(19) United States
(12) Patent Application Publication
(10) Pub. No.: US 2023/0398406 A1
(43) Pub. Date: Dec. 14, 2023

(54) CYCLING SPORT PERFORMANCE LEVEL ANALYSIS SYSTEM

(71) Applicant: UNIWILL TECHNOLOGY INC., TAIPEI CITY (TW)

(72) Inventors: Chien-Yuan CHEN, TAIPEI CITY (TW); Chun-Cheng CHEN, TAIPEI CITY (TW); Shao-Hong YANG, TAIPEI CITY (TW); Jen-Sheng TSAI, TAIPEI CITY (TW)

(21) Appl. No.: 18/126,391

(22) Filed: Mar. 25, 2023

(30) Foreign Application Priority Data
Jun. 9, 2022 (TW) 111121479

(51) Int. Cl. A63B 24/00; G06N 5/022; A63B 22/06

(52) U.S. Cl. CPC A63B 24/0062; G06N 5/022; A63B 22/06; A63B 24/0075; A63B 2024/009; A63B 2024/0093; A63B 2225/20; A63B 2071/0638

(57) ABSTRACT

A cycling sport performance level analysis system includes an artificial intelligence classification analysis module, a bicycle apparatus, a classification knowledge rule module and a cyclist information module. The classification knowledge rule module transmits a classification test task rule including a track information to the artificial intelligence classification analysis module and the bicycle apparatus. The bicycle apparatus performs the classification test task rule and collects a sport sensing information which is sensed to transmit the sport sensing information to the artificial intelligence classification analysis module. The cyclist information module transmits a cyclist basic information and a track historical riding information to the artificial intelligence classification analysis module. The artificial intelligence classification analysis module analyzes the sport sensing information, the track information, the cyclist basic information and the track historical riding information to generate a cycling sport performance level analysis result.

### BACKGROUND OF THE DISCLOSURE

### Technical Field

The present disclosure relates to a sport performance level analysis system, and especially relates to a cycling sport performance level analysis system.

### Description of Related Art

Sports, such as cycling, can promote human health, and performing sport training management and purchasing sport merchandises are the keys to achieve good sport results. For those who ride bicycles for sports, the cyclist must first understand his/her own sport performance level so that he/she can properly perform the sport training management and purchase appropriate sport merchandises. Some related arts use fixed sport training courses and sense the cyclist's heart rate, exertion force and so on through wearable apparatuses to assess the cyclist's sport performance level.

However, the related arts mentioned above do not integrate and analyze the multiple characteristic information of the cyclist, nor use the track information to control the sport apparatus for the level analysis and testing, and also lack the artificial intelligence model for training and analysis, which often results in the problems of insufficient analysis and evaluation of the cyclist's sport performance level.

### SUMMARY OF THE DISCLOSURE

In order to solve the above-mentioned problems, an object of the present disclosure is to provide a cycling sport performance level analysis system.

In order to achieve the object of the present disclosure mentioned above, the cycling sport performance level analysis system of the present disclosure includes an artificial intelligence classification analysis module, a bicycle apparatus, a classification knowledge rule module, and a cyclist information module. The bicycle apparatus is electrically connected to the artificial intelligence classification analysis module. The classification knowledge rule module is electrically connected to the artificial intelligence classification analysis module and the bicycle apparatus. The cyclist information module is electrically connected to the artificial intelligence classification analysis module. Moreover, the classification knowledge rule module transmits a classification test task rule to the artificial intelligence classification analysis module and the bicycle apparatus. The classification test task rule includes a track information. The bicycle apparatus performs the classification test task rule so that the bicycle apparatus is controlled based on the track information. The bicycle apparatus collects a sport sensing information sensed by the bicycle apparatus per unit time to transmit the sport sensing information to the artificial intelligence classification analysis module. The cyclist information module transmits a cyclist basic information and a track historical riding information to the artificial intelligence classification analysis module. The artificial intelligence classification analysis module analyzes the sport sensing information, the track information, the cyclist basic information and the track historical riding information to generate a cycling sport performance level analysis result. Based on the cycling sport performance level analysis result, the artificial intelligence classification analysis module performs a cyclist sport training management plan or recommends a sport merchandise.

Moreover, the cycling sport performance level analysis system further includes a cycling sport performance level analysis data base electrically connected to the artificial intelligence classification analysis module. Moreover, the artificial intelligence classification analysis module transmits the cycling sport performance level analysis result to the cycling sport performance level analysis database. The cycling sport performance level analysis database stores the cycling sport performance level analysis result.

Moreover, the bicycle apparatus includes a communication module electrically connected to the artificial intelligence classification analysis module and the classification knowledge rule module. Moreover, the communication module transmits the sport sensing information to the artificial intelligence classification analysis module through an internet.

Moreover, the bicycle apparatus further includes a sensing module electrically connected to the communication module. Moreover, the sensing module collects the sport sensing information sensed by the sensing module per unit time.

Moreover, the bicycle apparatus further includes a display module electrically connected to the communication module. Moreover, the display module displays the track information.

Moreover, the bicycle apparatus further includes a sport module. The display module is arranged on the sport module. Moreover, the sport module is controlled based on the track information.

Moreover, the sport sensing information includes a riding power, a riding speed, a riding rhythm and a cyclist image data.

Moreover, the cycling sport performance level analysis result includes an explosive sprint type and an endurance uniform speed type.

Moreover, the explosive sprint type includes a sprint entry level, a sprint general level, a sprint advanced level, a sprint development team level, a sprint youth professional level and a sprint elite level.

Moreover, the endurance uniform speed type includes a uniform speed entry level, a uniform speed general level, a uniform speed advanced level, a uniform speed development team level, a uniform speed youth professional level and a uniform speed elite level.

The advantage of the present disclosure is to accurately analyze and evaluate the sport performance level of the cyclist.

Please refer to the detailed descriptions and figures of the present disclosure mentioned below for further understanding the technology, method and effect of the present disclosure achieving the predetermined purposes. It believes that the purposes, characteristic and features of the present disclosure can be understood deeply and specifically. However, the figures are only for references and descriptions, but the present disclosure is not limited by the figures.

### BRIEF DESCRIPTION OF THE DRAWINGS

FIG. 1 shows a block diagram of the first embodiment of the cycling sport performance level analysis system of the present disclosure.

FIG. 2 shows a block diagram of the second embodiment of the cycling sport performance level analysis system of the present disclosure.

### DETAILED DESCRIPTION

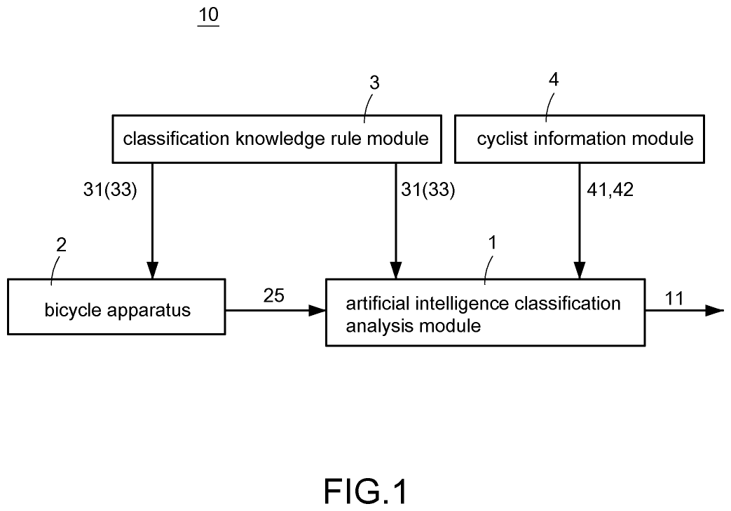

In the present disclosure, numerous specific details are provided, to provide a thorough understanding of embodiments of the disclosure. Persons of ordinary skill in the art will recognize, however, that the present disclosure can be practiced without one or more of the specific details. In other instances, well-known details are not shown or described to avoid obscuring aspects of the present disclosure. Now please refer to the figures for the explanation of the technical content and the detailed description of the present disclosure: FIG. 1 shows a block diagram of the first embodiment of the cycling sport performance level analysis system 10 of the present disclosure. A cycling sport performance level analysis system 10 of the present disclosure includes an artificial intelligence classification analysis module 1, a bicycle apparatus 2, a classification knowledge rule module 3 and a cyclist information module 4.

The components mentioned above are electrically connected to each other. In an embodiment of the present disclosure but not limiting the present disclosure, the artificial intelligence classification analysis module 1, the classification knowledge rule module 3 and the cyclist information module 4 are respective microprocessors, or may be integrated into a single microprocessor.

First, a cyclist (not shown in FIG. 1) rides on the bicycle apparatus 2 and presses a test start button (not shown in FIG. 1). Then, the classification knowledge rule module 3 transmits a classification test task rule 31 to the artificial intelligence classification analysis module 1 and the bicycle apparatus 2, wherein the classification test task rule 31 is a signal and includes a track information 33. Then, the bicycle apparatus 2 performs the classification test task rule 31 so that the bicycle apparatus 2 is controlled to change a pedaling difficulty and so on of the bicycle apparatus 2 based on the track information 33. Then, the cyclist starts to pedal the bicycle apparatus 2, and the bicycle apparatus 2 collects a sport sensing information 25 of the cyclist sensed by the bicycle apparatus 2 per unit time to transmit the sport sensing information 25 to the artificial intelligence classification analysis module 1.

The cyclist information module 4 transmits a cyclist basic information 41 and a track historical riding information 42 to the artificial intelligence classification analysis module 1. Finally, the artificial intelligence classification analysis module 1 analyzes the sport sensing information 25, the track information 33, the cyclist basic information 41 and the track historical riding information 42 to generate a cycling sport performance level analysis result 11 which is a signal. Based on the cycling sport performance level analysis result 11, the artificial intelligence classification analysis module 1 performs a cyclist sport training management plan or recommends a sport merchandise, detailed later.

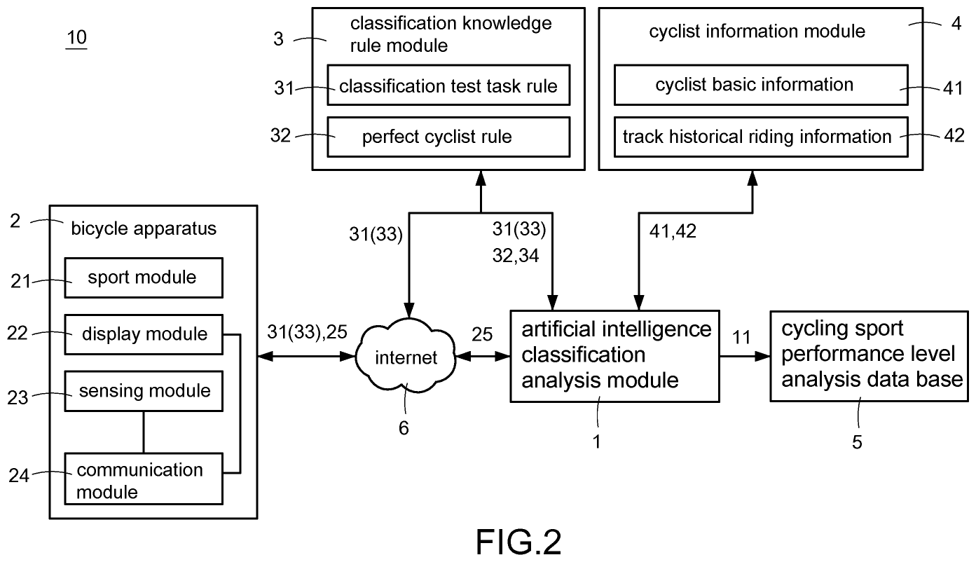

FIG. 2 shows a block diagram of the second embodiment of the cycling sport performance level analysis system 10 of the present disclosure. The descriptions of the elements shown in FIG. 2 which are the same as the elements shown in FIG. 1 are not repeated here for brevity. The cycling sport performance level analysis system 10 further includes a cycling sport performance level analysis data base 5 which is a data base and electrically connected to the artificial intelligence classification analysis module 1. The artificial intelligence classification analysis module 1 transmits the cycling sport performance level analysis result 11 to the cycling sport performance level analysis data base 5. The cycling sport performance level analysis data base 5 stores the cycling sport performance level analysis result 11.

The bicycle apparatus 2 includes a sport module 21, a display module 22, a sensing module 23 and a communication module 24. The communication module 24 is a communication circuit and electrically connected to the artificial intelligence classification analysis module 1, the classification knowledge rule module 3, the display module 22 and the sensing module 23. The display module 22 is a display and arranged on the sport module 21. The display module 22 displays the track information 33. The sport module 21 is controlled to change the pedaling difficulty and so on of the bicycle apparatus 2 based on the track information 33. The sensing module 23 collects the sport sensing information 25 of the cyclist sensed by the sensing module 23 per unit time. The communication module 24 transmits the sport sensing information 25 to the artificial intelligence classification analysis module 1 through an internet 6. The sport module 21 includes, for example but not limited to, bicycle components such as a bicycle frame, bicycle pedals and so on. The sensing module 23 is, for example but not limited to, a wearable apparatus.

The sport sensing information 25 includes a riding power, a riding speed, a riding rhythm, and a cyclist image data of the cyclist. The cycling sport performance level analysis result 11 includes an explosive sprint type and an endurance uniform speed type. The explosive sprint type includes a sprint entry level, a sprint general level, a sprint advanced level, a sprint development team level, a sprint youth professional level and a sprint elite level. The endurance uniform speed type includes a uniform speed entry level, a uniform speed general level, a uniform speed advanced level, a uniform speed development team level, a uniform speed youth professional level and a uniform speed elite level.

Moreover, please refer to FIG. 2 again. In another embodiment of the present disclosure but not limiting the present disclosure, the classification knowledge rule module 3 transmits a perfect cyclist rule 32 (which is a signal) and a classification knowledge rule 34 (which is a signal) to the artificial intelligence classification analysis module 1. The artificial intelligence classification analysis module 1 analyzes the perfect cyclist rule 32, the classification knowledge rule 34, the sport sensing information 25, the track information 33, the cyclist basic information 41 and the track historical riding information 42 to generate the cycling sport performance level analysis result 11. Moreover, the classification knowledge rule 34 includes the levels corresponding to Union Cycliste Internationale/World Cycling Centre (UCI/WCC) Power Profile Test, the levels corresponding to 6 Sec Peak Power, the levels corresponding to 30 Sec Sprint TestMean and the levels corresponding to 4 Minute Aerobic Test. The perfect cyclist rule 32 includes a perfect riding speed data, a perfect riding rhythm data and a perfect riding power data.

Moreover, the cyclist basic information 41 includes a cyclist weight data, a cyclist gender data, and a cyclist height data of the cyclist. The track information 33 includes a track length data and a track altitude data. The track historical riding information 42 includes a historical riding speed data, a historical riding rhythm data and a historical riding power data of the cyclist.

Moreover, the cyclist sport training management plan is performed based on the cycling sport performance level analysis result 11, a training purpose, a training intensity, and a training time. The cyclist sport training management plan includes a general basic introductory course, an endurance aerobic course, an explosive strength course and a muscle endurance interval course.

Moreover, about the recommended sport merchandise: For the sprint entry level and the uniform speed entry level, the thrust ratio of boys is less than 2.5 w/kg, the thrust ratio of girls is less than 1.5 w/kg, the weight of the vehicle is recommended to be less than 8 kg, the recommended parts for the body are comfortable type, the power meter/stopwatch is recommended to be basic type, the component grade is recommended to be 105/Ultegra, the weight of flat road wheels is recommended to be less than 1600 g, and the weight of climbing wheels is recommended to be less than 1400 g. For the sprint general level and the uniform speed general level, the thrust ratio of boys is 2.5˜6.0 w/kg, the thrust ratio of girls is 1.5˜4.0 w/kg, the weight of the vehicle is recommended to be less than 7.5 kg, the recommended parts for the body are comfortable/competitive type, the power meter/stopwatch is recommended to be basic type, the component grade is recommended to be 105/Ultegra, the weight of flat road wheels is recommended to be less than 1600 g, and the weight of climbing wheels is recommended to be less than 1400 g. For the sprint development team level and the uniform speed development team level, the thrust ratio of boys is 5.0˜6.0 w/kg, the thrust ratio of girls is 3.5˜4.0 w/kg, the weight of the vehicle is recommended to be less than 7.2 kg, the recommended parts for the body are competitive type, the power meter/stopwatch is recommended to be intermediate/advanced, the component grade is recommended to be Ultegra/DA, the weight of flat road wheels is recommended to be less than 1400 g, and the weight of climbing wheels is recommended to be less than 1350 g. For the sprint youth professional level and the uniform speed youth professional level, the thrust ratio of boys is 6.0˜7.0 w/kg, the thrust ratio of girls is 4.0˜5.0 w/kg, the weight of the vehicle is recommended to be less than 7.2 kg, the recommended parts for the body are competitive type, the power meter/stopwatch is recommended to be intermediate/advanced, the component grade is recommended to be Ultegra/DA, the weight of flat road wheels is recommended to be less than 1400 g, and the weight of climbing wheels is recommended to be less than 1350 g. For the sprint elite level and the uniform speed elite level, the thrust ratio of boys is 6.5˜7.0 w/kg, the thrust ratio of girls is 4.5˜5.5 w/kg, the weight of the vehicle is recommended to be less than 7.2 kg, the recommended parts for the body are competitive type, the power meter/stopwatch is recommended to be advanced, the component grade is recommended to be DA, the weight of flat road wheels is recommended to be less than 1400 g, and the weight of climbing wheels is recommended to be less than 1200 g.

The advantage of the present disclosure is to accurately analyze and evaluate the sport performance level of the cyclist. Moreover, the present disclosure combines the classification test task rule 31 with the display module 22 and the sport module 21 of the bicycle apparatus 2, so that the present disclosure may make the test more conform to the real track riding.

Although the present disclosure has been described with reference to the embodiment thereof, it will be understood that the disclosure is not limited to the details thereof. Various substitutions and modifications have been suggested in the foregoing description, and others will occur to those of ordinary skill in the art. Therefore, all such substitutions and modifications are intended to be embraced within the scope of the disclosure as defined in the appended claims.

What is claimed is:

1. A cycling sport performance level analysis system comprising:
an artificial intelligence classification analysis module;
a bicycle apparatus electrically connected to the artificial intelligence classification analysis module;
a classification knowledge rule module electrically connected to the artificial intelligence classification analysis module and the bicycle apparatus; and
a cyclist information module electrically connected to the artificial intelligence classification analysis module,
wherein the classification knowledge rule module is configured to transmit a classification test task rule to the artificial intelligence classification analysis module and the bicycle apparatus; the classification test task rule comprises a track information; the bicycle apparatus is configured to perform the classification test task rule so that the bicycle apparatus is configured to be controlled based on the track information; the bicycle apparatus is configured to collect a sport sensing information sensed by the bicycle apparatus per unit time to transmit the sport sensing information to the artificial intelligence classification analysis module; the cyclist information module is configured to transmit a cyclist basic information and a track historical riding information to the artificial intelligence classification analysis module; the artificial intelligence classification analysis module is configured to analyze the sport sensing information, the track information, the cyclist basic information and the track historical riding information to generate a cycling sport performance level analysis result; based on the cycling sport performance level analysis result, the artificial intelligence classification analysis module is configured to perform a cyclist sport training management plan or recommends a sport merchandise.

2. The cycling sport performance level analysis system of claim 1, further comprising:
a cycling sport performance level analysis data base electrically connected to the artificial intelligence classification analysis module,
wherein the artificial intelligence classification analysis module is configured to transmit the cycling sport performance level analysis result to the cycling sport performance level analysis data base; the cycling sport performance level analysis data base is configured to store the cycling sport performance level analysis result.

3. The cycling sport performance level analysis system of claim 2, wherein the bicycle apparatus comprises:
a communication module electrically connected to the artificial intelligence classification analysis module and the classification knowledge rule module,
wherein the communication module is configured to transmit the sport sensing information to the artificial intelligence classification analysis module through an internet.

4. The cycling sport performance level analysis system of claim 3, wherein the bicycle apparatus further comprises:
a sensing module electrically connected to the communication module,
wherein the sensing module is configured to collect the sport sensing information sensed by the sensing module per unit time.

5. The cycling sport performance level analysis system of claim 4, wherein the bicycle apparatus further comprises:
a display module electrically connected to the communication module,
wherein the display module is configured to display the track information.

6. The cycling sport performance level analysis system of claim 5, wherein the bicycle apparatus further comprises:
a sport module,
wherein the display module is arranged on the sport module; the sport module is configured to be controlled based on the track information.

7. The cycling sport performance level analysis system of claim 6, wherein the sport sensing information comprises a riding power, a riding speed, a riding rhythm, and a cyclist image data.

8. The cycling sport performance level analysis system of claim 7, wherein the cycling sport performance level analysis result comprises an explosive sprint type and an endurance uniform speed type.

9. The cycling sport performance level analysis system of claim 8, wherein the explosive sprint type comprises a sprint entry level, a sprint general level, a sprint advanced level, a sprint development team level, a sprint youth professional level and a sprint elite level.

10. The cycling sport performance level analysis system of claim 9, wherein the endurance uniform speed type comprises a uniform speed entry level, a uniform speed general level, a uniform speed advanced level, a uniform speed development team level, a uniform speed youth professional level and a uniform speed elite level.
